(19) United States
(12) Patent Application Publication
(10) Pub. No.: US 2026/0296155 A1
(43) Pub. Date: Oct. 1, 2026

(54) FUEL CELL VEHICLE

(71) Applicant: HONDA MOTOR CO., LTD., TOKYO (JP)

(72) Inventor: Takuya KANDA, WAKO-SHI (JP)

(21) Appl. No.: 19/573,110

(22) Filed: Mar. 20, 2026

(30) Foreign Application Priority Data
Mar. 25, 2025 (JP) 2025-050065

(51) Int. Cl. B60K 1/00; B62D 21/02

(52) U.S. Cl. CPC B60K 1/00; B62D 21/02

(57) ABSTRACT

A fixing structure of a fuel cell vehicle includes a first fastening member and a second fastening member provided so as to intersect each other in a plan view, and a support portion configured to support the first fastening member and the second fastening member to be pivotable with respect to each other. The first fastening member is connected to a first front connection portion of a first side frame and a second rear connection portion of a second side frame. The second fastening member is connected to a first rear connection portion of the first side frame and a second front connection portion of the second side frame.

### CROSS-REFERENCE TO RELATED APPLICATIONS

This application is based upon and claims the benefit of priority from Japanese Patent Application No. 2025-050065 filed on Mar. 25, 2025, the contents of which are incorporated herein by reference.

### BACKGROUND OF THE INVENTION

### FIELD OF THE INVENTION

The present disclosure relates to a fuel cell vehicle.

### DESCRIPTION OF THE RELATED ART

JP 2005-231549 A discloses a fuel cell vehicle in which a fuel cell system is mounted. A fuel cell vehicle is provided with a fuel cell module and a mounting member, which is mounted to a side of the fuel cell module. The fuel cell module is fixed to a side frame of a vehicle body frame via the mounting member.

### SUMMARY OF THE INVENTION

A separation distance (inter-frame distance) between a pair of side frames in the vehicle width direction differs for each type of vehicle. Therefore, it is desired that the fuel cell module can be effectively fixed to the pair of side frames in accordance with the inter-frame distance.

The present disclosure aims to solve the aforementioned problems.

An aspect of the present disclosure is a fuel cell vehicle that includes a vehicle body frame having a first side frame and a second side frame, a fuel cell module, and a fixing structure configured to fix the fuel cell module to the first side frame and the second side frame, wherein the first side frame is arranged on one side in the vehicle width direction, the second side frame is arranged on another side in the vehicle width direction and faces the first side frame, the first side frame includes a first front connection portion to which the fixing structure is fixed and a first rear connection portion provided rearward of the first front connection portion, the second side frame includes a second front connection portion to which the fixing structure is fixed and a second rear connection portion provided rearward of the second front connection portion, the fixing structure includes a first fastening member and a second fastening member connected to the first side frame and the second side frame, respectively, and provided to intersect each other in a plan view, and a support portion provided at the intersection portion of the first fastening member and the second fastening member and supporting the first fastening member and the second fastening member to be pivotable with respect to each other, the first fastening member is connected to the first front connection portion of the first side frame and the second rear connection portion of the second side frame, and the second fastening member is connected to the first rear connection portion of the first side frame and the second front connection portion of the second side frame.

According to the present disclosure, it is possible to effectively fix the fuel cell module to the first side frame and the second side frame by relatively pivot the first fastening member and the second fastening member with respect to the support portion according to the separation distance between the first side frame and the second side frame in the vehicle width direction.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a configuration diagram of a fuel cell vehicle according to an embodiment of the present disclosure;

FIG. 2 is an enlarged plan view of FIG. 1;

FIG. 3 is a cross-sectional view taken along line III-III of FIG. 2;

FIG. 4 is a cross-sectional view taken along line IV-IV of FIG. 2; and

FIG. 5 is an explanatory diagram for a case where the fuel cell module is fixed to a fuel cell vehicle whose inter-frame distance is different from that of the fuel cell vehicle shown in FIG. 2.

### DETAILED DESCRIPTION OF THE INVENTION

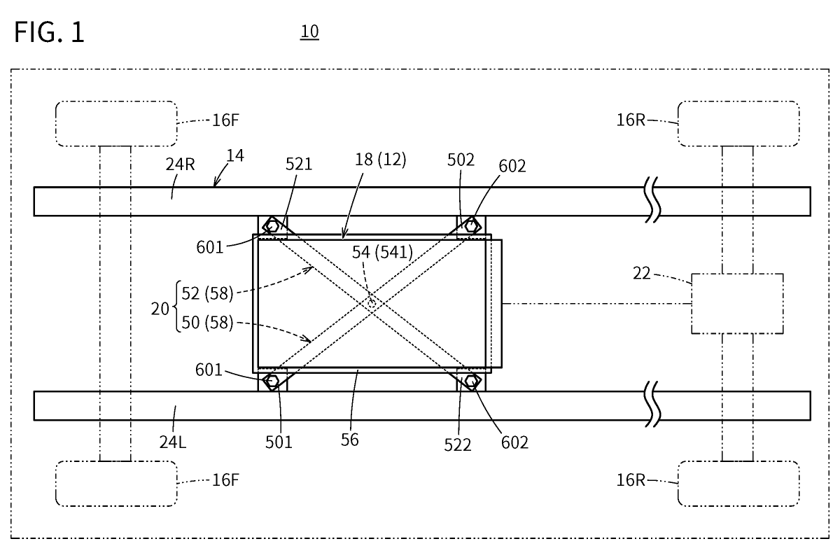

As shown in FIG. 1, a fuel cell vehicle 10 according to the present embodiment is equipped with a fuel cell system 12. The fuel cell vehicle 10 includes a vehicle body frame 14, front wheels 16F, rear wheels 16R, a cell module 18, a fixing structure 20, and a motor 22. The motor 22 operates by the power supplied from the fuel cell module 18. The motor 22 drives at least the front wheels 16F or the rear wheels 16R. The motor 22 is fixed to, for example, the vehicle body frame 14.

The vehicle body frame 14 includes a first side frame 24L and a second side frame 24R. Each of the first side frame 24L and the second side frame 24R extends along the vehicle front-rear direction (hereinafter referred to as the “front-rear direction") of the fuel cell vehicle 10 (hereinafter also referred to as the vehicle 10).

The first side frame 24L is arranged on one side in the vehicle width direction. The second side frame 24R is arranged on the other side in the vehicle width direction. The first side frame 24L and the second side frame 24R face each other in the vehicle width direction of the vehicle 10. The first side frame 24L and the second side frame 24R are provided in parallel with each other with a predetermined width (hereinafter referred to as "inter-frame distance WF") apart in the vehicle width direction.

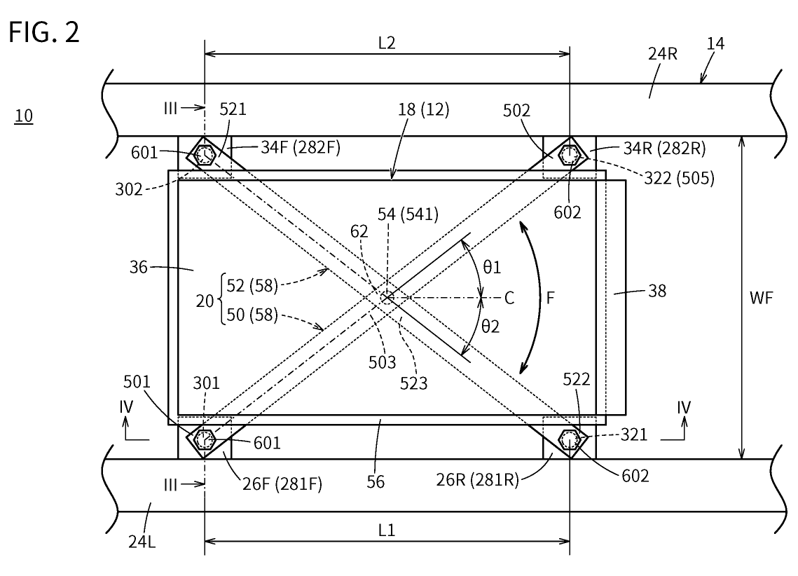

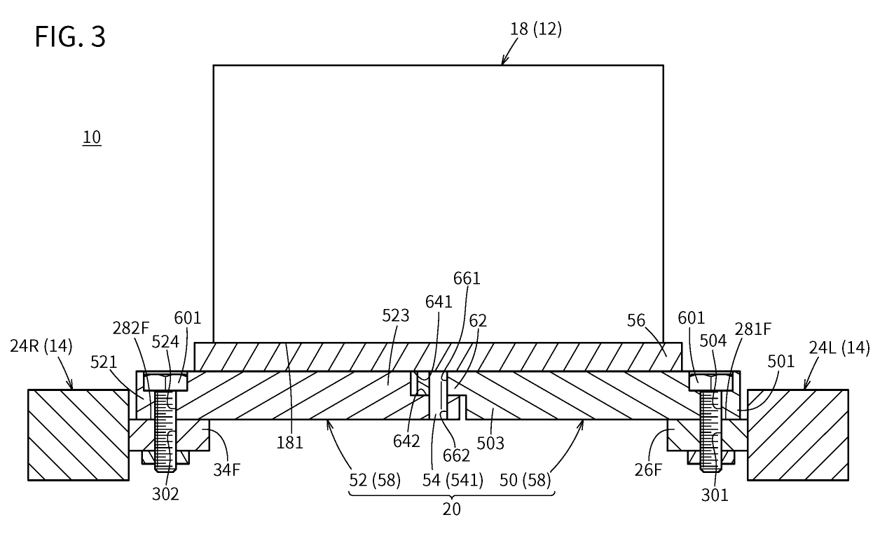

As shown in FIG. 2, the first side frame 24L includes a first front connection portion 26F and a first rear connection portion 26R to which the fixing structure 20 is fixed. The first front connection portion 26F projects inward in the vehicle width direction from an inner end portion of the first side frame 24L. As shown in FIG. 3, the first front connection portion 26F has a first front mounting surface 281F and a first mounting hole 301. The first front mounting surface 281F is a surface facing upward. The first mounting hole 301 is open to the first front mounting surface 281F and extends in the up-down direction.

As shown in FIG. 2, the first rear connection portion 26R is provided vehicle-rearward (hereinafter referred to as “rearward") of the first front connection portion 26F. The first rear connection portion 26R projects inward in the vehicle width direction from the inner end portion of the first side frame 24L. The first rear connection portion 26R has a first rear mounting surface 281R and a second mounting hole 321. The first rear mounting surface 281R is a surface facing upward. The second mounting hole 321 is open to the first rear mounting surface 281R and extends in the up-down direction. In the front-rear direction of the vehicle 10, the first front connection portion 26F and the first rear connection portion 26R are separated from each other by a first distance L1.

The second side frame 24R is provided with a second front connection portion 34F and a second rear connection portion 34R to which the fixing structure 20 is fixed. The second front connection portion 34F faces the first front connection portion 26F in the vehicle width direction. The second front connection portion 34F projects inward in the vehicle width direction from an inner end portion of the second side frame 24R. As shown in FIG. 3, the second front connection portion 34F has a second front mounting surface 282F and a first mounting hole 302. The second front mounting surface 282F is a surface facing upward. The first mounting hole 302 is open to the second front mounting surface 282F and extends in the up-down direction.

As shown in FIG. 2, the second rear connection portion 34R is provided rearward of the second front connection portion 34F. The second rear connection portion 34R faces the first rear connection portion 26R in the vehicle width direction. The second rear connection portion 34R projects inward in the vehicle width direction from the inner end portion of the second side frame 24R. The second rear connection portion 34R has a second rear mounting surface 282R and a second mounting hole 322. The second rear mounting surface 282R is a surface facing upward. The second mounting hole 322 is open to the second rear mounting surface 282R and extends in the up-down direction. In the front-rear direction of the vehicle 10, the second front connection portion 34F and the second rear connection portion 34R are separated from each other by a second distance L2.

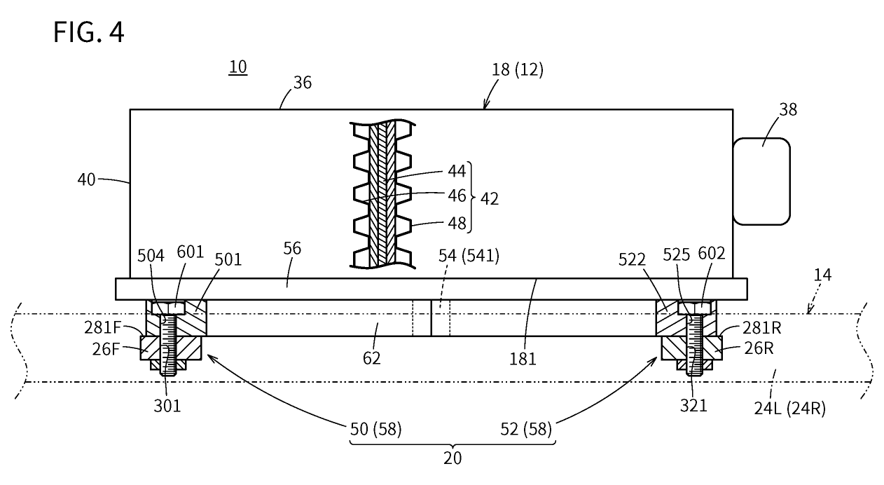

The fuel cell module 18 is fixed to the first side frame 24L and the second side frame 24R by the fixing structure 20. As shown in FIG. 4, the fuel cell module 18 includes a fuel cell stack 36 and a plurality of auxiliary devices 38 for driving the fuel cell stack 36. The fuel cell stack 36 has a stack case 40 and a plurality of power generating cells 42. The stack case 40 accommodates a plurality of power generating cells 42.

The plurality of power generating cells 42 generates power through an electrochemical reaction between an anode gas (fuel gas such as hydrogen) supplied from an anode system device and a cathode gas (oxygen containing gas such as air) supplied from a cathode system device. Each power generating cell 42 is composed of a membrane electrode assembly 44 and two separators 46, 48 sandwiching the membrane electrode assembly 44. The plurality of power generating cells 42 are stacked in the front-rear direction of the vehicle 10 with electrode surfaces in a standing posture. The upper surface of the fuel cell stack 36 is located at a higher position than the first side frame 24L and the second side frame 24R.

As shown in FIG. 2, the fixing structure 20 fixes the fuel cell module 18 to the first side frame 24L and the second side frame 24R.

The fixing structure 20 includes a first fastening member 50 and a second fastening member 52, a support portion 54, and a support plate 56. A fastening portion 58 is formed from the first fastening member 50 and the second fastening member 52.

The first fastening member 50 and the second fastening member 52 are supported by a bottom portion 181 of the fuel cell module 18 (see FIG. 3). The first fastening member 50 and the second fastening member 52 are provided so as to intersect each other in a plan view. The first fastening member 50 and the second fastening member 52 are respectively connected to the first side frame 24L and the second side frame 24R. Each of the first fastening member 50 and the second fastening member 52 is formed from a long plate-like member. The first fastening member 50 and the second fastening member 52 are not limited to a case where they are formed from plate-like members.

The first fastening member 50 includes a first end portion 501, a second end portion 502, and a first intermediate portion 503. The first end portion 501 is provided at one end portion in the extending direction of the first fastening member 50. The first end portion 501 is connected to the first front mounting surface 281F of the first front connection portion 26F of the first side frame 24L. As shown in FIG. 3, the first end portion 501 has a first through-hole 504. The first through-hole 504 penetrates in the up-down direction orthogonal to the extending direction of the first fastening member 50. A front fastening bolt 601 is inserted into the first through-hole 504. The front fastening bolt 601 is fastened to the first mounting hole 301 via the first through-hole 504. The first end portion 501 of the first fastening member 50 is supported in a pivotable manner with respect to the first front connection portion 26F by the front fastening bolt 601 (see FIG. 2).

As shown in FIG. 2, the second end portion 502 is provided at the other end portion in the extending direction of the first fastening member 50. The second end portion 502 is connected to the second rear mounting surface 282R of the second rear connection portion 34R of the second side frame 24R. That is, the first fastening member 50 is provided at an angle with respect to the extending direction of the first side frame 24L and the second side frame 24R.

The second end portion 502 has a second through-hole 505. The second through-hole 505 penetrates in the up-down direction orthogonal to the extending direction of the first fastening member 50. A rear fastening bolt 602 is inserted into the second through-hole 505. The rear fastening bolt 602 is fastened to the second mounting hole 322 via the second through-hole 505. The second end portion 502 of the first fastening member 50 is supported by the rear fastening bolt 602 to be pivotable with respect to the second rear connection portion 34R. The pivot direction of the first fastening member 50 is a horizontal direction (F-direction) orthogonal to the axial directions of the front fastening bolt 601 and the rear fastening bolt 602.

The first intermediate portion 503 is provided between the first end portion 501 and the second end portion 502 in the extending direction of the first fastening member 50. In a plan view, the first intermediate portion 503 is an intersection portion 62 intersecting the second fastening member 52. As shown in FIG. 3, the first intermediate portion 503 includes a first notch portion 641 and a first hole portion 661. The first notch portion 641 is cut out in the thickness direction at the first intermediate portion 503. The first notch portion 641 is eccentrically positioned in the thickness direction from the center in the thickness direction of the first fastening member 50. The first hole portion 661 penetrates in the thickness direction orthogonal to the extending direction of the first fastening member 50. That is, the first hole portion 661 penetrates in the up-down direction of the vehicle 10.

As shown in FIG. 2, the second fastening member 52 is formed to have the same shape as the first fastening member 50. The length of the second fastening member 52 along the extending direction and the length of the first fastening member 50 along the extending direction are equal.

The second fastening member 52 includes a first end portion 521, a second end portion 522, and a second intermediate portion 523. The first end portion 521 is provided at one end portion in the extending direction of the second fastening member 52. The first end portion 521 is connected to the second front mounting surface 282F of the second front connection portion 34F of the second side frame 24R. As shown in FIG. 3, the first end portion 521 has a first through-hole 524. The first through-hole 524 penetrates in the up-down direction orthogonal to the extending direction of the second fastening member 52. The front fastening bolt 601 is inserted into the first through-hole 524. The front fastening bolt 601 is fastened to the first mounting hole 302 via the first through-hole 524. The first end portion 521 of the second fastening member 52 is supported by the front fastening bolt 601 in a pivotable manner with respect to the second front connection portion 34F.

The second end portion 522 is provided at the other end portion in the extending direction of the second fastening member 52. The second end portion 522 is connected to the first rear mounting surface 281R of the first rear connection portion 26R of the first side frame 24L. That is, the second fastening member 52 is provided at an angle with respect to the extending direction of the first side frame 24L and the second side frame 24R. As shown in FIG. 4, the second end portion 522 has a second through-hole 525. The second through-hole 525 penetrates in the up-down direction orthogonal to the extending direction of the second fastening member 52. The rear fastening bolt 602 is inserted into the second through-hole 525. The rear fastening bolt 602 is fastened to the second mounting hole 321 via the second through-hole 525. The second end portion 522 of the second fastening member 52 is supported by the rear fastening bolt 602 to be pivotable with respect to the first rear connection portion 26R. The pivot direction of the second fastening member 52 is a horizontal direction (F-direction in FIG. 2) orthogonal to the axial directions of the front fastening bolt 601 and the rear fastening bolt 602.

As shown in FIG. 2, the second intermediate portion 523 is provided between the first end portion 521 and the second end portion 522 in the extending direction of the second fastening member 52. In a plan view, the second intermediate portion 523 is an intersection portion 62 intersecting the first fastening member 50. As shown in FIG. 3, the second intermediate portion 523 includes a second notch portion 642 and a second hole portion 662. The second notch portion 642 is cutout in the thickness direction at the second intermediate portion 523. The second notch portion 642 is eccentrically positioned in the thickness direction from the center in the thickness direction of the second fastening member 52 and overlaps the first notch portion 641 in the thickness direction. The first notch portion 641 of the first intermediate portion 503 and the second notch portion 642 of the second intermediate portion 523 overlap each other in the thickness direction to form the intersection portion 62. The second hole portion 662 penetrates in the thickness direction orthogonal to the extending direction of the second fastening member 52. That is, the second hole portion 662 penetrates in the up-down direction of the vehicle 10.

The support portion 54 supports a central portion of the fuel cell module 18 in a plan view (see FIG. 2). The support portion 54 is provided at the intersection portion 62 between the first fastening member 50 and the second fastening member 52. The support portion 54 supports the first fastening member 50 and the second fastening member 52 to be pivotable relative to each other. The support portion 54 has a support member 541. The support member 541 is inserted into the first hole portion 661 of the first fastening member 50 and the second hole portion 662 of the second fastening member 52. The first intermediate portion 503 of the first fastening member 50 and the second intermediate portion 523 of the second fastening member 52 are supported to be pivotable relative to each other via the support portion 54.

As shown in FIG. 2, in a plan view, the first end portion 501 of the first fastening member 50 and the second end portion 522 of the second fastening member 52 are arranged in the front-rear direction of the vehicle 10, and the second end portion 502 of the first fastening member 50 and the first end portion 521 of the second fastening member 52 are arranged in the front-rear direction of the vehicle 10. In a plan view, the first fastening member 50 and the second fastening member 52 are formed in an X-shape.

The width of the fixing structure 20 can be changed by horizontally pivoting each of the first fastening member 50 and the second fastening member 52 about the support portion 54 as a fulcrum. Specifically, by pivoting each of the first fastening member 50 and the second fastening member 52, it is possible to change the first angle θ1 of the first fastening member 50 and the second angle θ2 of the second fastening member 52 with respect to a virtual line C passing through the support portion 54 and extending along the front-rear direction with respect to the vehicle 10.

The first end portion 501 of the first fastening member 50 and the first end portion 521 of the second fastening member 52 are pivoted so as to approach each other in the vehicle width direction, thereby reducing the width between the first end portion 501 of the first fastening member 50 and the first end portion 521 of the second fastening member 52. That is, the width of the fixing structure 20 is reduced by pivoting the fixing structure 20 in such a way that each of the first angle θ1 and the second angle θ2 is reduced. At this time, the distance between the first end portion 501 and the second end portion 502 of the first fastening member 50 and the distance between the first end portion 521 and the second end portion 522 of the second fastening member 52 become larger in the front-rear direction of the vehicle 10.

The first end portion 501 of the first fastening member 50 and the first end portion 521 of the second fastening member 52 are pivoted so as to move away from each other in the vehicle width direction, thereby increasing the width between the first end portion 501 of the first fastening member 50 and the first end portion 521 of the second fastening member 52. That is, the width of the fixing structure 20 is increased by pivoting the fixing structure 20 in such a way that each of the first angle θ1 and the second angle θ2 is increased. At this time, the distance between the first end portion 501 and the second end portion 502 of the first fastening member 50 and the distance between the first end portion 521 and the second end portion 522 of the second fastening member 52 become smaller in the front-rear direction of the vehicle 10.

The configuration is not limited to a case where the support portion 54 includes the support member 541. For example, one of the first fastening member 50 and the second fastening member 52 may be provided with a shaft portion that projects in the thickness direction and is inserted into an intermediate hole, and the first fastening member 50 and the second fastening member 52 may be supported to be rotatable relative to each other via the shaft portion.

As shown in FIG. 3, the support plate 56 is provided between the fastening portion 58 (the first fastening member 50 and the second fastening member 52) and the fuel cell module 18. As shown in FIG. 2, the support plate 56 covers a lower portion of the fuel cell module 18 in a plan view. The support plate 56 supports the lower portion of the fuel cell module 18. The support plate 56 is fixed to the fastening portion 58.

Next, a case where the fuel cell module 18 is assembled to the first side frame 24L and the second side frame 24R in the fuel cell vehicle 10 will be described.

The fuel cell module 18 is fixed to the fixing structure 20, and the fuel cell module 18 together with the fixing structure 20 is inserted between the first side frame 24L and the second side frame 24R. The first fastening member 50 and the second fastening member 52 are pivoted relative to each other with the support portion 54 being as a fulcrum in accordance with the inter-frame distance WF between the first side frame 24L and the second side frame 24R.

Specifically, the first fastening member 50 and the second fastening member 52 are pivoted relative to each other to match the distance in the width direction between the first front connection portion 26F and the second front connection portion 34F. The first fastening member 50 and the second fastening member 52 are pivoted relative to each other in such a way that, in a plan view, the first end portion 501 of the first fastening member 50 and the first front connection portion 26F overlap each other and the first end portion 521 of the second fastening member 52 and the second front connection portion 34F overlap each other. At this time, the second end portion 502 of the first fastening member 50 and the second rear connection portion 34R overlap each other, and the second end portion 522 of the second fastening member 52 and the first rear connection portion 26R overlap each other.

Then, as shown in FIG. 3, the front fastening bolt 601 is fastened to the first mounting hole 301 of the first front connection portion 26F via the first through-hole 504 of the first fastening member 50, and the rear fastening bolt 602 is fastened to the second mounting hole 322 of the second rear connection portion 34R via the second through-hole 505 of the first fastening member 50 (see FIG. 2). The front fastening bolt 601 is fastened to the first mounting hole 302 of the second front connection portion 34F via the first through-hole 524 of the second fastening member 52, and as shown in FIG. 4, the rear fastening bolt 602 is fastened to the second mounting hole 321 of the first rear connection portion 26R via the second through-hole 525 of the second fastening member 52. As a result, as shown in FIG. 2, the first fastening member 50 and the second fastening member 52 that intersect each other to form a X-shape in a plan view are fixed to the first side frame 24L and the second side frame 24R, respectively. In a plan view, the fuel cell module 18 is fixed between the first side frame 24L and the second side frame 24R via the fixing structure 20.

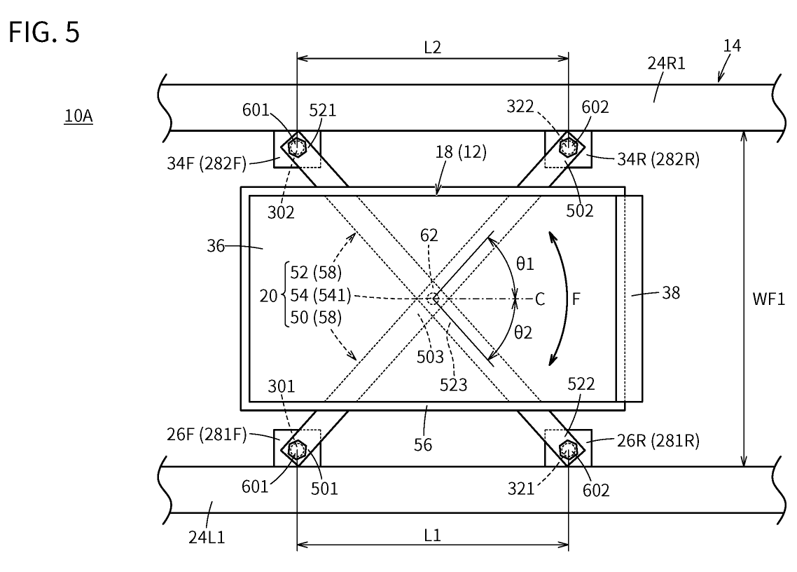

Next, a case where the fuel cell module 18 is fixed via the fixing structure 20 to a fuel cell vehicle 10A with a different inter-frame distance WF between the first side frame 24L and the second side frame 24R will be described with reference to FIG. 5. Here, a case will be described where an inter-frame distance WF1 between a first side frame 24L1 and a second side frame 24R1 is larger than the inter-frame distance WF of the vehicle 10 described above.

As shown in FIG. 5, the fuel cell vehicle 10A (hereinafter also referred to as vehicle 10A) is provided with the first side frame 24L1 and the second side frame 24R1 arranged at the inter-frame distance WF1. The width of the fixing structure 20 is increased by pivoting the first fastening member 50 and the second fastening member 52 relative to each other about the support portion 54 as a fulcrum in accordance with the inter-frame distance WF1.

Specifically, the first fastening member 50 and the second fastening member 52 are pivoted around the support portion 54 as a fulcrum in such a way that, in a plan view, the first end portion 501 of the first fastening member 50 and the second end portion 522 of the second fastening member 52 approach each other in the front-rear direction of the vehicle 10A. At this time, the pivot direction of the first fastening member 50 and the pivot direction of the second fastening member 52 are opposite to each other.

By pivoting the first fastening member 50 and the second fastening member 52, the width between the first end portion 501 of the first fastening member 50 and the first end portion 521 of the second fastening member 52 in the vehicle width direction increases. The first fastening member 50 and the second fastening member 52 are pivoted relative to each other in such a way that, in a plan view, the first end portion 501 of the first fastening member 50 and the first front connection portion 26F overlap each other and the first end portion 521 of the second fastening member 52 and the second front connection portion 34F overlap each other. At this time, the second end portion 502 of the first fastening member 50 and the second rear connection portion 34R overlap each other, and the second end portion 522 of the second fastening member 52 and the first rear connection portion 26R overlap each other. Thus, the width of the fixing structure 20 is increased in response to the inter-frame distance WF1 by the pivoting of the first fastening member 50 and the second fastening member 52.

In this case, each of the first distance L1 of the first side frame 24L1 and the second distance L2 of the second side frame 24R1 is inversely proportional to the inter-frame distance WF1 between the first side frame 24L1 and the second side frame 24R1.

Then, the first fastening member 50 is fastened to the first front connection portion 26F and the second rear connection portion 34R by the front fastening bolt 601 and the rear fastening bolt 602, respectively, and the second fastening member 52 is fastened to the second front connection portion 34F and the first rear connection portion 26R by the front fastening bolt 601 and the rear fastening bolt 602. Thus, the fuel cell module 18 is fixed to the first side frame 24L1 and the second side frame 24R1 of the vehicle 10A having a different inter-frame distance WF1 via the fixing structure 20.

The present embodiment provides the following benefits.

As shown in FIG. 1, the fixing structure 20 of the fuel cell vehicle 10 includes the first fastening member 50 and the second fastening member 52 provided so as to intersect each other in a plan view, and a support portion 54 for supporting the first fastening member 50 and the second fastening member 52 to be pivotable with respect to each other. The first fastening member 50 is connected to the first front connection portion 26F of the first side frame 24L and the second rear connection portion 34R of the second side frame 24R. The second fastening member 52 is connected to the first rear connection portion 26R of the first side frame 24L and the second front connection portion 34F of the second side frame 24R.

According to this fuel cell vehicle 10, the fuel cell module 18 can be effectively fixed to the first side frame 24L and the second side frame 24R by relatively rotating the first fastening member 50 and the second fastening member 52 with respect to the support portion 54 in accordance with the separation distance (inter-frame distance WF) between the first side frame 24L and the second side frame 24R in the vehicle width direction.

In the front-rear direction of the vehicles 10, 10A, the first front connection portion 26F and the first rear connection portion 26R are separated by the first distance L1, and the second front connection portion 34F and the second rear connection portion 34R are separated by the second distance L2. Each of the first distance L1 and the second distance L2 is inversely proportional to the inter-frame distances WF, WF1 between the first side frames 24L, 24L1 and the second side frames 24R, 24R1, respectively.

According to this configuration, the first fastening member 50 and the second fastening member 52 can be effectively fixed to various vehicles 10, 10A having different distances between the first side frames 24L, 24L1 and the second side frames 24R, 24R1.

As shown in FIG. 3, the support portion 54 includes the first hole portion 661 being provided in the first fastening member 50 and penetrating in the up-down direction, the second hole portion 662 being provided in the second fastening member 52 and penetrating in the up-down direction, and the support member 541 being inserted into the first hole portion 661 and the second hole portion 662.

According to this structure, the first fastening member 50 and the second fastening member 52 can be configured to be pivotable with a simple structure.

As shown in FIG. 2, the support portion 54 supports a central portion of the fuel cell module 18 in a plan view of the vehicle 10. According to this configuration, the central portion of the fuel cell module 18 having the center of gravity can be effectively supported by the central portions of the first fastening member 50 and the second fastening member 52.

As shown in FIG. 3, the first fastening member 50 and the second fastening member 52 are supported by the bottom portion 181 of the fuel cell module 18.

According to this structure, the fuel cell module 18 can be effectively fixed to the first side frame 24L and the second side frame 24R by the first fastening member 50 and the second fastening member 52.

The support plate 56 is provided between the fastening portion 58 and the fuel cell module 18 to support the fuel cell module 18 and to be fixed to the fastening portion 58.

According to this configuration, the first fastening member 50 and the second fastening member 52 can be pivoted more effectively while the bottom portion 181 of the fuel cell module 18 is effectively held.

As shown in FIG. 2, the first fastening member 50 and the second fastening member 52 are formed in an X-shape in a plan view.

With respect to the above disclosure, the following supplementary notes are further disclosed.

### Supplementary note 1

A fuel cell vehicle (10, 10A) includes a vehicle body frame (14) having a first side frame (24L, 24L1) and a second side frame (24R, 24R1), a fuel cell module (18), and a fixing structure (20) configured to fix the fuel cell module to the first side frame and the second side frame, wherein the first side frame is arranged on one side in the vehicle width direction, the second side frame is arranged on another side in the vehicle width direction and faces the first side frame, the first side frame includes a first front connection portion (26F) to which the fixing structure is fixed and a first rear connection portion (26R) provided rearward of the first front connection portion, the second side frame includes a second front connection portion (34F) to which the fixing structure is fixed and a second rear connection portion (34R) provided rearward of the second front connection portion, the fixing structure includes a first fastening member (50) and a second fastening member (52) connected to the first side frame and the second side frame, respectively, and provided to intersect each other in a plan view, and a support portion (54) provided at the intersection portion (62) of the first fastening member and the second fastening member and supporting the first fastening member and the second fastening member to be pivotable with respect to each other, the first fastening member is connected to the first front connection portion of the first side frame and the second rear connection portion of the second side frame, and the second fastening member is connected to the first rear connection portion of the first side frame and the second front connection portion of the second side frame.

According to such a fuel cell vehicle, the fuel cell module can be effectively fixed to the first side frame and the second side frame by relatively pivoting the first fastening member and second fastening member with respect to the support portion in accordance with the separation distance between the first side frame and the second side frame in the vehicle width direction.

### Supplementary note 2

In the fuel cell vehicle of Supplementary note 1, in the front-rear direction of the fuel cell vehicle, the first front connection portion and the first rear connection portion may be separated by a first distance (L1), the second front connection portion and the second rear connection portion may be separated by a second distance (L2), and each of the first distance and the second distance may be inversely proportional to the inter-frame distance (WF, WF1) that is the width between the first side frame and the second side frame in the vehicle width direction.

According to this configuration, the first fastening member and the second fastening member can be effectively fixed to various vehicles having different frame distances between the first side frame and the second side frame.

### Supplementary note 3

In the fuel cell vehicle described in Supplementary note 2, the intersection portion may be formed by overlapping a central portion in the extending direction of the first fastening member and a central portion in the extending direction of the second fastening member in the plan view, and the support portion may include a first hole portion (661) provided at the first fastening member and penetrating in the up-down direction orthogonal to the front-rear direction and the vehicle width direction, a second hole portion (662) provided at the second fastening member and penetrating in the up-down direction, and a support member (541) inserted into the first hole portion and the second hole portion.

According to this structure, the first fastening member and the second fastening member can be configured to be pivotable with a simple structure.

### Supplementary note 4

In the fuel cell vehicle of Supplementary note 3, the support portion may support a central portion of the fuel cell module in the plan view.

According to this configuration, the central portion of the fuel cell module having the center of gravity can be effectively supported by the central portions of the first fastening member and the second fastening member.

### Supplementary note 5

In the fuel cell vehicle of Supplementary note 1, the first fastening member and the second fastening member may be supported by the bottom portion (181) of the fuel cell module.

According to such a configuration, the fuel cell module can be effectively fixed to the first side frame and the second side frame by the first and second fastening members.

### Supplementary note 6

In the fuel cell vehicle described in Supplementary note 1, the fixing structure may include a fastening portion (58) constituted by the first fastening member and the second fastening member, and the fuel cell vehicle may further include a support plate (56) between the fastening portion and the fuel cell module, the support plate supporting the fuel cell module and being fixed to the fastening portion.

According to this configuration, the first fastening member and the second fastening member can be pivoted more effectively while the bottom portion of the fuel cell module is effectively held.

### Supplementary note 7

In the fuel cell vehicle of Supplementary note 1, the first fastening member and the second fastening member may be formed in an X-shape in a plan view.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A fuel cell vehicle comprising:
a vehicle body frame including a first side frame and a second side frame;
a fuel cell module; and
a fixing structure configured to fix the fuel cell module to the first side frame and the second side frame,
wherein
the first side frame is arranged on one side in a vehicle width direction, and the second side frame is arranged on another side in the vehicle width direction and faces the first side frame,
the first side frame includes a first front connection portion to which the fixing structure is fixed and a first rear connection portion provided rearward of the first front connection portion,
the second side frame includes a second front connection portion to which the fixing structure is fixed and a second rear connection portion provided rearward of the second front connection portion,
the fixing structure includes
a first fastening member and a second fastening member connected to the first side frame and the second side frame, respectively, and provided to intersect each other in a plan view, and
a support portion provided at an intersection portion of the first fastening member and the second fastening member and configured to support the first fastening member and the second fastening member to be pivotable with respect to each other,
the first fastening member is connected to the first front connection portion of the first side frame and the second rear connection portion of the second side frame, and
the second fastening member is connected to the first rear connection portion of the first side frame and the second front connection portion of the second side frame.

2. The fuel cell vehicle according to claim 1, wherein
in a front-rear direction of the fuel cell vehicle, the first front connection portion and the first rear connection portion are separated by a first distance, and the second front connection portion and the second rear connection portion are separated by a second distance, and
each of the first distance and the second distance is inversely proportional to an inter-frame distance that is a width between the first side frame and the second side frame in the vehicle width direction.

3. The fuel cell vehicle according to claim 2, wherein
the intersection portion is formed by overlapping a central portion in an extending direction of the first fastening member and a central portion in an extending direction of the second fastening member in the plan view, and
the support portion includes
a first hole portion provided at the first fastening member and penetrating in an up-down direction orthogonal to the front-rear direction and the vehicle width direction,
a second hole portion provided at the second fastening member and penetrating in the up-down direction, and
a support member inserted into the first hole portion and the second hole portion.

4. The fuel cell vehicle according to claim 3, wherein
in the plan view, the support portion supports a central portion of the fuel cell module.

5. The fuel cell vehicle according to claim 1, wherein
the first fastening member and the second fastening member are supported by a bottom portion of the fuel cell module.

6. The fuel cell vehicle according to claim 1, wherein
the fixing structure includes a fastening portion constituted by the first fastening member and the second fastening member, and
the fuel cell vehicle further comprises a support plate between the fastening portion and the fuel cell module, the support plate supporting the fuel cell module and being fixed to the fastening portion.

7. The fuel cell vehicle according to claim 1, wherein
in the plan view, the first fastening member and the second fastening member are formed in an X-shape.
